(19) United States
(12) Patent Application Publication
(10) Pub. No.: US 2025/0008874 A1
(43) Pub. Date: Jan. 9, 2025

(54) ASSISTED STEERING SYSTEMS AND ASSOCIATED DEVICES AND METHODS FOR AGRICULTURAL VEHICLES

(71) Applicant: Ag Leader Technology, Ames, IA (US)

(72) Inventor: Kurt Townsend, Ames, IA (US)

(21) Appl. No.: 18/766,374

(22) Filed: Jul. 8, 2024

Related U.S. Application Data
(60) Provisional application No. 63/525,525, filed on Jul. 7, 2023.

(51) Int. Cl. A01D 41/127; A01B 69/04

(52) U.S. Cl. CPC A01D 41/1278; A01B 69/008

(57) ABSTRACT

A system for automatic or assisted steering of an agricultural harvester, comprising one or more snoot sensors configured to sense alignment of the harvester with a harvest row, at least one processor in communication with the one or more snoot sensors, a control system in communication with the at least one processor and an automatic steering system, wherein the control system is configured to command the automatic steering system to drive the harvester along the row in response to feedback from the one or more snoot sensors.

### CROSS-REFERENCE TO RELATED APPLICATION(S)

This application claims the benefit under 35 U.S.C. § 119(e) to U.S. Provisional Application 63/525,525, filed Jul. 7, 2023, and entitled Assisted Steering Systems and Associated Devices and Methods for Agricultural Vehicles, which is incorporated herein by reference in its entirety for all purposes.

### TECHNICAL FIELD

The disclosure relates to row crop harvesters and more particularly to assisted/automated driving and steering of harvesters.

### BACKGROUND

As would be appreciated, typically harvesters are driven manually, which is subject to human error and fatigue. Various assisted steering and positioning systems are known in the art including those disclosed in U.S. Patent Publication 2022/0317688, U.S. Pat. Nos. 4,197,690, 9,936,637, and 4,967,362.

There is a need in the art for improved devices, systems, and methods for automatic and/or assisted steering of harvest vehicles.

### BRIEF SUMMARY

Disclosed herein are various devices, systems, and methods for assisted and/or automatic steering of row crop harvesters (e.g., combines) during harvest operations. In various implementations, the system includes one or more snoot sensors configured to sense alignment of the combine with a harvest row(s), at least one processor in communication with the one or more snoot sensors, a control system in communication with the at least one processor, and an automatic steering system, wherein the control system is configured to command the automatic steering system to drive the combine along the row in response to feedback from the one or more snoot sensors.

The snoot sensors may be one or more of the following sensor types: pivotable snoot, load cell, thin film pressure sensor, magnetic sensor, proximity sensor, capacitive sensor, and the like.

In Example 1, a system for automatic or assisted steering of an agricultural harvester, comprising one or more snoot sensors configured to sense alignment of the harvester with a harvest row, at least one processor in communication with the one or more snoot sensors, a control system in communication with the at least one processor, and an automatic steering system in communication with the control system, wherein the control system is configured to command the automatic steering system to drive the harvester along the row in response to feedback from the one or more snoot sensors.

Example 2 relates to the system of any of Examples 1 and 3-9, wherein the one or more snoot sensors are selected from a pivotable snoot sensor, a load cell, a thin film pressure sensor, a magnetic sensor, a proximity sensor, and a capacitive sensor.

Example 3 relates to the system of any of Examples 1-2 and 4-9, wherein the one or more snoot sensors is a pivotable snoot sensor comprising a snoot configured for translational movement about a point and a rotation sensor on the snoot configured to measure the translational movement of the snoot from stalks impacting the snoot.

Example 4 relates to the system of any of Examples 1-3 and 5-9, wherein the one or more snoot sensors is a load cell sensor comprising a snoot configured for translational movement about a gauged pin and a load cell in communication with the gauged pin configured to measure strain on the pin in response to force on the snoot from impacting stalks.

Example 5 relates to the system of any of Examples 1-4 and 6-9, wherein the one or more snoot sensors is a pressure sensor comprising a snoot and a pressure ribbon along an underside of the snoot, wherein pressure from impacting stalks is sensed by the pressure ribbon.

Example 6 relates to the system of any of Examples 1-5 and 7-9, further comprising a pressure ribbon on opposing snoots of a harvester row unit.

Example 7 relates to the system of any of Examples 1-6 and 8-9, wherein the one or more snoot sensors is a magnetic sensor comprising at least one magnet disposed on an underside of a snoot and a magnetic field sensor configured to detect changes to a magnetic field of the at least one magnet from rotation of the snoot from impacting stalks.

Example 8 relates to the system of any of Examples 1-7 and 9, wherein at least one of the one or more snoot sensors is located on each snoot of a header.

Example 9 relates to the system of any of Examples 1-8, wherein the one or more snoot sensor are located on a single row unit of a header.

In Example 10, an agricultural steering system, comprising a harvester head comprising one or more row units, the one or more row units divided by snoots, a steering system, a control unit in communication with the steering system, and at least one snoot sensor on the snoots in communication with the control unit configured to detect row alignment, wherein feedback from the at least one snoot sensor is processed by the control unit to command the steering system to navigate a harvester along a row.

Example 11 relates to the agricultural steering system of any of Examples 10 and 12-15, further comprising at least one snoot sensor on each of the snoots.

Example 12 relates to the agricultural steering system of any of Examples 10-11 and 13-15, wherein the at least one snoot sensor is a pivotable sensor comprising a snoot configured for translational movement about a point and a rotation sensor on the snoot configured to measure the translational movement of the snoot from stalks impacting the snoot.

Example 13 relates to the agricultural steering system of any of Examples 10-12 and 14-15, wherein the at least one snoot sensor is a load cell sensor comprising a snoot configured for translational movement about a gauged pin and a load cell in communication with the gauged pin configured to measure strain on the pin in response to force on the snoot from impacting stalks.

Example 14 relates to the agricultural steering system of any of Examples 10-13 and 15, wherein the at least one snoot sensor is a pressure sensor comprising a snoot and a pressure ribbon along an underside of the snoot, wherein pressure from impacting stalks is sensed by the pressure ribbon.

Example 15 relates to the agricultural steering system of any of Examples 10-14, wherein the at least one snoot sensor is a magnetic sensor comprising at least one magnet disposed on an underside of a snoot and a magnetic field sensor configured to detect changes to a magnetic field of the at least one magnet from rotation of the snoot from impacting stalks.

In Example 16, an automatic steering system for a row crop harvester comprising a snoot configured for translational movement about a point, a rotation sensor on the snoot configured to measure the translational movement of the snoot from stalks impacting the snoot, and a processor in communication with the rotation sensor configured to command an automatic steering system in response to inputs from the rotation sensor.

Example 17 relates to the automatic steering system of any of Examples 16 and 18-20, wherein a degree of rotation detected by the rotation sensor causes a proportional degree of correction by the automatic steering system.

Example 18 relates to the automatic steering system of any of Examples 16-17 and 19-20, further comprising a machine learning model configured to processes inputs from the rotation sensor to provide guidance to the automatic steering system.

Example 19 relates to the automatic steering system of any of Examples 16-18 and 20, wherein the automatic steering system mechanically steers the row crop harvester via one or more devices.

Example 20 relates to the automatic steering system of any of Examples 16-19, wherein a corrective commands to the automatic steering system are sent in response to a threshold degree of rotation detected by the rotation sensor.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic diagram of a harvester implementing the system, according to one implementation.

FIG. 2 is a system diagram, according to one implementation.

FIG. 3 is a top view of a portion of a row crop header having a pivotal or load cell snoot sensor, according to one implementation.

FIG. 4 is a top view of a portion of a row crop header having a pressure sensor, according to one implementation.

FIG. 5 is a top view of a portion of a row crop header having a magnetic sensor, according to one implementation.

### DETAILED DESCRIPTION

Described herein are various devices, systems, and method for assisted or automatic steering of combines through field or other agricultural areas. In various implementations, the system includes one or more sensors on or about a snoot to determine if the combine is aligned properly with the crop rows, at least one processor, a control system, and an automatic or assisted steering system. In various implementations the systems is configured to command the automatic or assisted steering system to drive the harvester so a to align with the crop rows to maximize yield and increase efficiency in harvest operations.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,334, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. Patent Application 63/525,525, filed Jul. 7, 2023, entitled “Assisted Steering Systems and Associated Devices and Methods for Agricultural Vehicles,” U.S. Patent Application 63/593,837, filed Oct. 27, 2023, entitled “Agricultural Implement Position Sensor and Related Devices, Systems, and Methods,” U.S. Patent Application 63/603,969, filed Nov. 29, 2023, entitled “Devices, Systems and Methods for Guidance Line Shifting,” U.S. Patent Application 63/607,227, filed Dec. 7, 2023, entitled “Header Height Control Devices, Systems and Methods,” U.S. Patent Application 63/609,758, filed Dec. 13, 2023, entitled “Magnetic Stripper/Deck Plate Sensing System,” U.S. Patent Application 63/626,744, filed Jan. 30, 2024, entitled “Grain Cart Unloading Sensor and Unload Control,” U.S. Patent Application 63/646,038, filed May 13, 2024, entitled “Seed Tube Camera and Related Devices, Systems, and Methods,” U.S. Patent Application 63/646,068, filed May 13, 2024, entitled “Seed Tube Camera and Related Devices, Systems, and Methods,” U.S. Patent Application 63/651,831, filed May 24, 224, entitled “Non-Contact Methods for Interactions in Navigational Space of Relatively Located Mobile Systems, and Related Devices and Systems,” U.S. Patent Application 63/654,634, filed May 31, 2024, entitled “Equipment Thermal Monitoring System and Associated Methods and Devices,” U.S. Patent Application 63/667,546, filed Jul. 3, 2024, entitled “Cover for Port Openings,” and U.S. Patent Application 63/667,530, filed Jul. 3, 2024, entitled “Agricultural Seed Meters and Related Devices, Systems and Methods,” each of which is incorporated herein by reference.

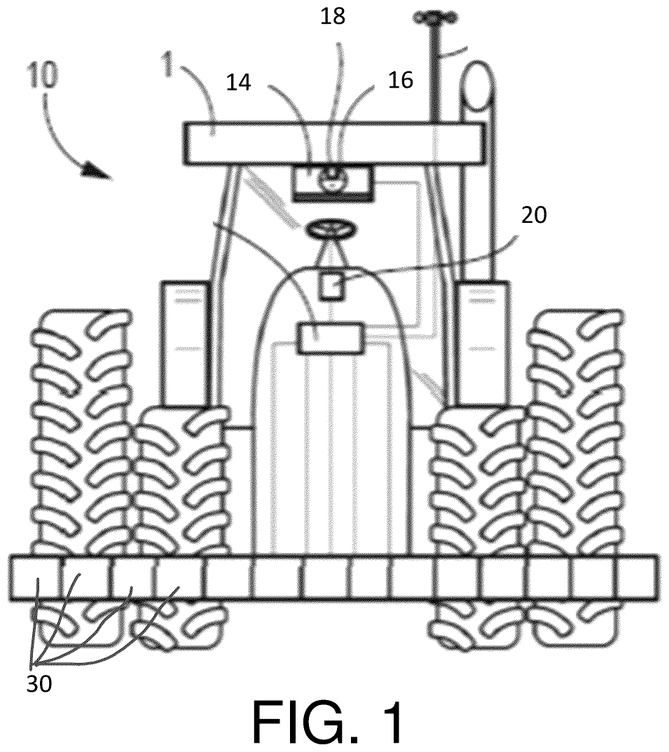

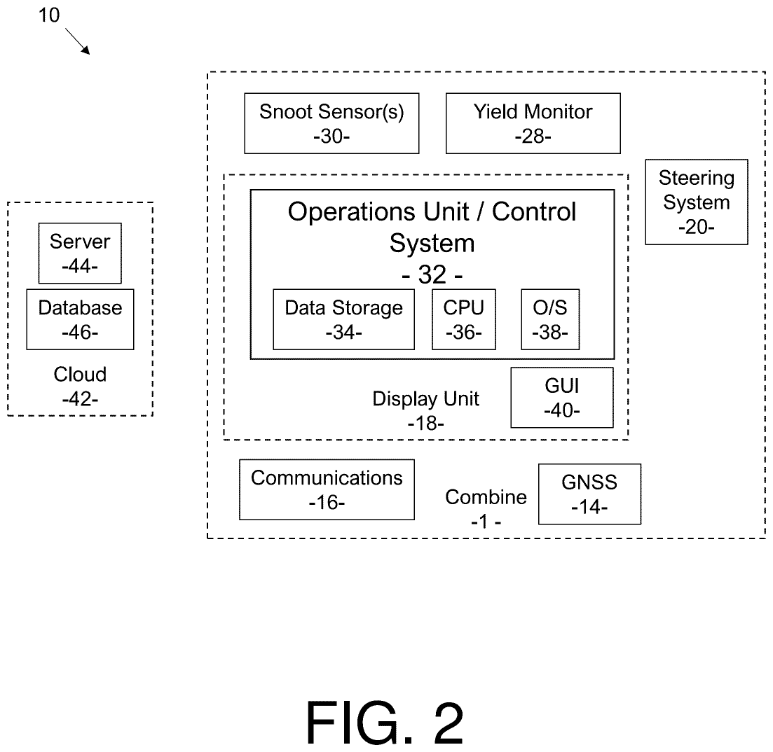

Turning to the figures in more detail, in various implementations the system 10 is in place on a combine 1 or similar harvest vehicle 1, as would be understood, shown in FIG. 1. In various implementations, the combine system 10 includes a GNSS or GPS receiver 14, one or more snoot sensors 30 in operational communication with a vehicle system display 18, such as the InCommand® display from Ag Leader®, and an operations unit 32, as is shown in greater detail in FIG. 2. The system 10 optionally comprises at least one yield monitor 28 and various additional sensors, monitors and the like, as would be appreciated by those of skill in the art.

The system 10 further includes an automatic and/or assisted steering system 20. Various automatic and/or assisted steering systems 20 are configured to take inputs from an operations unit 32 and snoot sensors 30 and navigate a vehicle through a field as directed. Various steering systems 20 may manually and/or electronically manipulate the systems on board a harvest vehicle 1 to effectuate automatic and/or assisted steering, as would be appreciated by those of skill in the art.

Continuing with FIGS. 1 and 2, in various implementations, the vehicle system 10, and optionally integrated within the display 18, is an operations unit 32 in operational communication with data link 16 (also referred to herein as a communications component 16). It is generally understood that these components may optionally be housed within the display unit 18 and that the representation of FIG. 2 is merely exemplary.

In certain implementations, the operations unit 32 is also configured for the sending and receiving of data for storage and processing, such as to the cloud 42, a remote server 44, database 46, and/or other cloud computing components readily understood in the art. Such connections by the operations unit 32, can be made wirelessly via understood internet and/or cellular technologies such as Bluetooth, Wi-Fi, LTE, 3G, 4G, or 5G connections, and the like. It is understood that in certain implementations, the operations unit 32 and/or cloud 42 component may comprise encryption or other data privacy components such as hardware, software, and/or firmware security aspects.

Continuing with FIG. 2, the operations unit 32, according to certain implementations, further has one or more optional processing and computing components, such as data storage 34, a CPU or processor 36, an operating system (“O/S”) 38, and other computing components necessary for implementing the various technologies disclosed herein. It is appreciated that the various optional system components are in operational communication with one another via wired or wireless connections and are configured to perform the processes and execute the commands described herein. As would be understood, each of these components can be located optionally at various locations around the vehicle or elsewhere, such as in the cloud 42 and accessible by a wireless or cellular connection.

In various implementations, this connectivity means that an operator, enterprise manager, and/or other third party is able to receive notifications such as adjustment prompts and confirmation screens on their mobile devices or via another access point. In certain implementations, these individuals can review the various data collected or recorded by the system 10 and make adjustments, comments, and/or observations in real-time or near real-time, as would be readily appreciated.

As shown in FIGS. 1 and 2, the system 10 includes at least snoot sensor 30 that is in operational communication with the system 10 and operations unit 32 via the communications component or data link 16. It is understood that in certain implementations, the snoot sensor(s) 30 are in direct operational communication with the operations unit 32 and/or steering system 20, and that it is calibrated to utilize raw data values generated by those sensors 30 to perform various steering related tasks as will be discussed in further detailed herein.

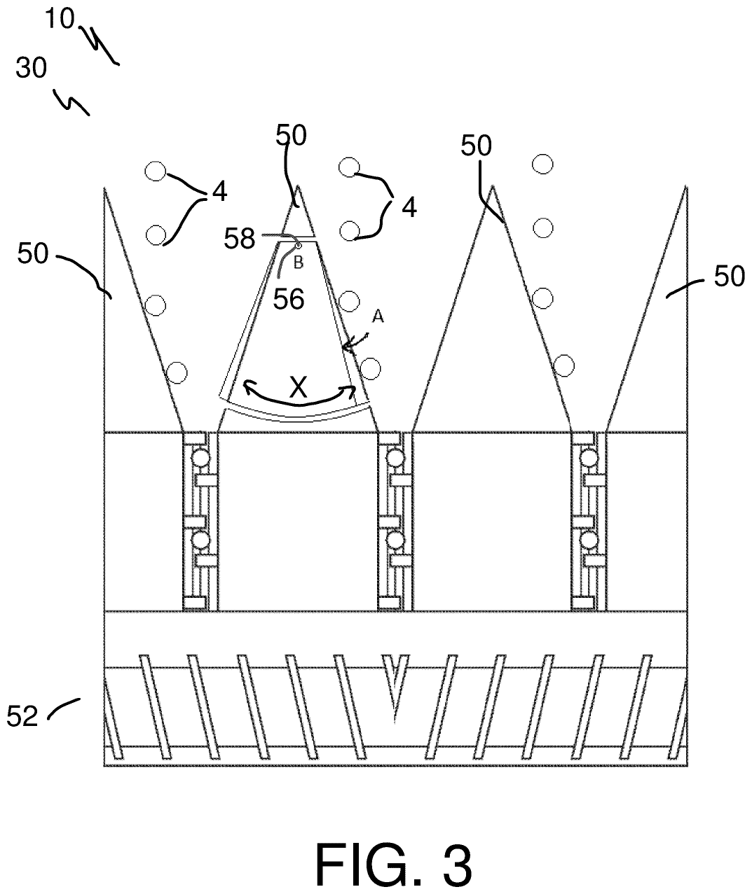

Turning to FIG. 3 in various implementations, the snoot sensors 30 are configured to sense stalk contact via force, pressure, or displacement of the snoot 50. As would be understood, the harvest head 52, such as a corn head 52, includes a plurality of snoots 50 dividing the corn head 52 into row units for harvesting row crops 4, such as corn 4. There are many ways to which this could be implemented, not limited to a pivotable snoot design, shown in FIG. 3. In these and other implementations, as stalks 4 hit snoot 30 at point A, snoot 30 moves translationally (along arrow X), pivots about a point B, for example point B. A rotational sensor at point B provides output to the operations unit 32/steering system 20 to shift the combine 1 left to align gathering chains with rows of stalks 4. In these and other implementations, the amount of angular rotation detected by the rotation sensor (snoot sensor 30) is correlated to off-row-distance. That is a greater about of rotation indicates a greater shift in guidance line is needed to align the vehicle 1 and header 52 with the incoming row or stalks 4. In various implementations, the sensor 30/snoot 50 includes spring return to force the snoot 50 back to its home/neutral position once the vehicle is realigned with the crop row. By realigning with the crop row and returning the snoot 50 to a neutral position, the sensor 30 will cease sensing rotation and instruct the steering system 20 that further correction is not necessary.

In an alternative implementation, the snoot sensor 30 has a load cell 56 design. In these implementations, similar to the pivotable snoot design, as stalks 4 hit the snoot 50, the snoot 50 is gauged directly or a custom load cell 56 is created to replace an OEM (original equipment manufacturer) part or snoot 50 is designed so that forces are funneled to a gauged part 58, such as a gauged pin 58 at location B, shown in FIG. 3, to sense force (indirectly via strain) perpendicular to direction of travel, in either right or left direction. In these and other implementations, the control system 32 uses signal(s) from gauged part 58 and load cell 56 to center or move combine 1 to minimize and balance forces sensed.

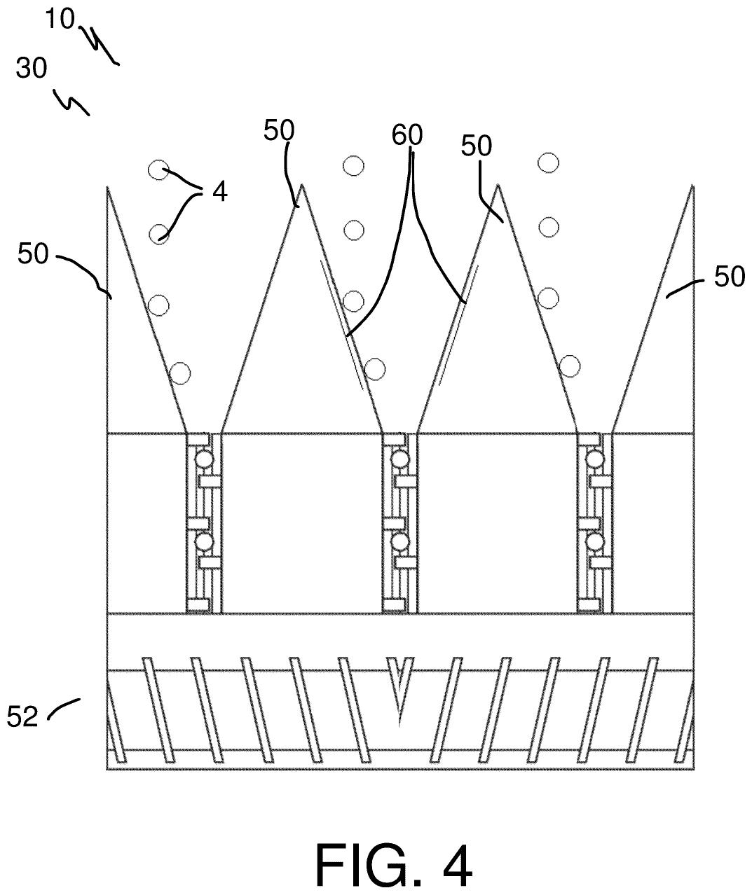

In a further alternative implementation, the snoot sensor 30 is a thin file pressure sensor 60, shown in FIG. 4. In these implementations, a thin film pressure ribbon 60 is mounted to the underside of snoot 50 to sense pressure. Various thin film ribbon sensors 60 are known in the art, such as those sold by Walfront part number Walfront2aqviy5odw. Similar to the implementations, discussed above, as pressure is applied to the ribbon 60 a signal is sent from the snoot sensor 30 to the operation unit 32/steering system 20 to steer the vehicle left to realign with the row of stalks 4. Greater pressure indicating a greater shift in guidance is required to align the vehicle 1. Once realignment is achieved the stalks 4 flow directly into the row unit of the header 52 and will not contact the snoot 50 or ribbon sensor 60. When no pressure is detected at the ribbon sensor 60 the vehicle is aligned with the row and not adjustments are necessary by the automatic steering system 20.

A still further alternative is a magnetic snoot sensor 30 design. In these implementations, magnets 62 are placed on underside surface(s) of snoot 30. A magnetic field sensor 64 is placed to sense the magnetic field as snoot 50 slightly deflects from stalk 4 contact, thus moving the magnets 62. In these implementations, the system 10 is configured to move the vehicle 1 in the opposite direction until magnetic field detected by the sensor 64 is stable or equal on each side of snoot 50.

Further alternative snoot sensors 30 may include: proximity sensors, capacitive sensors, and other sensor types, as would be appreciated. One or more different types of snoot sensors 30 may in used together or separately on one row unit, head 52, or vehicle 1.

In various implementations, the system 10 issues commands for the automatic/assisted steering system 20 to correct the path or guidance of the harvester 1 only when the snoot sensors 30 detect a threshold level of misalignment (i.e. a threshold amount of rotation, strain, pressure, change in magnetic field, and the like), and/or for a threshold period of time. Various thresholds may be user defined or derived from computer or machine learning algorithms.

In various implementations, the system 10 can use a combination of different types of snoot sensors 30. Some implementations may also include stalk sensors, such as those described in U.S. patent application Ser. No. 18/087,413 and U.S. patent application Ser. No. 18/116,714, incorporated herein by reference. The incorporation of various types of sensors include snoot and stalk sensors may allow for both macro and micro adjustments to harvester steering.

In certain implementations, snoot sensors 30 are placed on each and every snoot 50 of the combine head 52. In alternative implementations, snoot sensors 30 may be placed on just one or a few snoots 50 of the combine head 52. In implementations having more than one snoot sensor 30, the snoot sensors 30 may be isolated from one another, as shown for example in FIG. 4 where there are pressure ribbon sensors are two separate snoots and are not connected. In implementations, having more than one snoot sensor 30 if conflicting signals are received, some indicating a correction is needed while others indicated that the harvester 1 is aligned, the operations unit 30 may include various logic and/or machine learning to balance and decide if a correction is necessary.

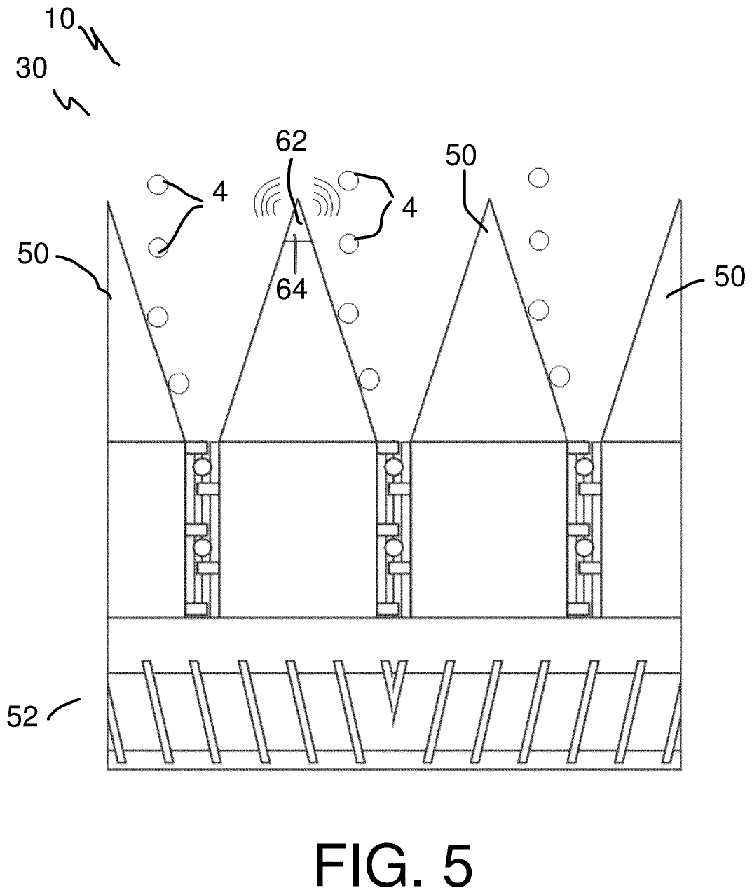

In some implementations, the snoot tip could be replaced with a snoot tip with embedded sensors 30 to sense stalk locations, feed to controller, combine shifts steering to align with rows, as shown in FIG. 5.

By allowing for micro and/or macro adjustments to combine 1 steering via and automatic or assisted steering systems 20 the system 10 resolves the problem of driving a combine 1 down the rows manually. This could result in improved yield, reduce operator fatigue, and reduced crop damage.

As would be appreciated in light of this disclosure, the system 10 may operate to have a similar outcome to navigation using row feelers. As described herein, by embedding the sensors 30 in the snoot 50, a more durable design is achieved. Further, this disclosed implementation will not get caught on stalks 4 when combine is in reverse due to the protection of the snoot 50. If sensors 30 are mounted on adjacent snoots, such as shown in FIG. 2, while facing each other, then system 1 could be used to harvest one row automatically.

Although the disclosure has been described with references to various embodiments, persons skilled in the art will recognize that changes may be made in form and detail without departing from the spirit and scope of this disclosure.

What is claimed is:

1. A system for automatic or assisted steering of an agricultural harvester, comprising:
(a) one or more snoot sensors configured to sense alignment of the harvester with a harvest row;
(b) at least one processor in communication with the one or more snoot sensors;
(c) a control system in communication with the at least one processor; and
(d) an automatic steering system in communication with the control system,
wherein the control system is configured to command the automatic steering system to drive the harvester along the row in response to feedback from the one or more snoot sensors.

2. The system of claim 1, wherein the one or more snoot sensors are selected from a pivotable snoot sensor, a load cell, a thin film pressure sensor, a magnetic sensor, a proximity sensor, and a capacitive sensor.

3. The system of claim 1, wherein the one or more snoot sensors is a pivotable snoot sensor comprising:
(a) a snoot configured for translational movement about a point; and
(b) a rotation sensor on the snoot configured to measure the translational movement of the snoot from stalks impacting the snoot.

4. The system of claim 1, wherein the one or more snoot sensors is a load cell sensor comprising:
(a) a snoot configured for translational movement about a gauged pin; and
(b) a load cell in communication with the gauged pin configured to measure strain on the pin in response to force on the snoot from impacting stalks.

5. The system of claim 1, wherein the one or more snoot sensors is a pressure sensor comprising:
(a) a snoot; and
(b) a pressure ribbon along an underside of the snoot,
wherein pressure from impacting stalks is sensed by the pressure ribbon.

6. The system of claim 5, further comprising a pressure ribbon on opposing snoots of a harvester row unit.

7. The system of claim 1, wherein the one or more snoot sensors is a magnetic sensor comprising:
(a) at least one magnet disposed on an underside of a snoot; and
(b) a magnetic field sensor configured to detect changes to a magnetic field of the at least one magnet from rotation of the snoot from impacting stalks.

8. The system of claim 1, wherein at least one of the one or more snoot sensors is located on each snoot of a header.

9. The system of claim 1, wherein the one or more snoot sensor are located on a single row unit of a header.

10. An agricultural steering system, comprising:
(a) a harvester head comprising one or more row units, the one or more row units divided by snoots;
(b) a steering system;
(c) a control unit in communication with the steering system; and
(d) at least one snoot sensor on the snoots in communication with the control unit configured to detect row alignment,
wherein feedback from the at least one snoot sensor is processed by the control unit to command the steering system to navigate a harvester along a row.

11. The agricultural steering system of claim 10, further comprising at least one snoot sensor on each of the snoots.

12. The agricultural steering system of claim 10, wherein the at least one snoot sensor is a pivotable sensor comprising:
(a) a snoot configured for translational movement about a point; and
(b) a rotation sensor on the snoot configured to measure the translational movement of the snoot from stalks impacting the snoot.

13. The agricultural steering system of claim 10, wherein the at least one snoot sensor is a load cell sensor comprising:
(a) a snoot configured for translational movement about a gauged pin; and
(b) a load cell in communication with the gauged pin configured to measure strain on the pin in response to force on the snoot from impacting stalks.

14. The agricultural steering system of claim 10, wherein the at least one snoot sensor is a pressure sensor comprising:
(a) a snoot; and
(b) a pressure ribbon along an underside of the snoot,
wherein pressure from impacting stalks is sensed by the pressure ribbon.

15. The agricultural steering system of claim 10, wherein the at least one snoot sensor is a magnetic sensor comprising:
(a) at least one magnet disposed on an underside of a snoot; and
(b) a magnetic field sensor configured to detect changes to a magnetic field of the at least one magnet from rotation of the snoot from impacting stalks.

16. An automatic steering system for a row crop harvester comprising:
(a) a snoot configured for translational movement about a point;
(b) a rotation sensor on the snoot configured to measure the translational movement of the snoot from stalks impacting the snoot; and
(c) a processor in communication with the rotation sensor configured to command an automatic steering system in response to inputs from the rotation sensor.

17. The automatic steering system of claim 16, wherein a degree of rotation detected by the rotation sensor causes a proportional degree of correction by the automatic steering system.

18. The automatic steering system of claim 16, further comprising a machine learning model configured to processes inputs from the rotation sensor to provide guidance to the automatic steering system.

19. The automatic steering system of claim 16, wherein the automatic steering system mechanically steers the row crop harvester via one or more devices.

20. The automatic steering system of claim 16, wherein a corrective commands to the automatic steering system are sent in response to a threshold degree of rotation detected by the rotation sensor.
